(19) United States
(12) Patent Application Publication
(10) Pub. No.: US 2016/0281870 A1
(43) Pub. Date: Sep. 29, 2016

(54) REVERSE PRESSURE RELIEF VALVE TO REDUCE DOOR CLOSING VELOCITY/EFFORT

(71) Applicant: GM Global Technology Operations LLC, Detroit, MI (US)

(72) Inventors: PRAMOD B. THANEDAR, CANTON, MI (US); JAMES H. SHOEMAKER, WHITE LAKE, MI (US); MICHAEL A. BREHLER, NOVI, MI (US); PHILIP C. JACKSON, CROSS PLAINS, TN (US)

(21) Appl. No.: 14/669,578

(22) Filed: Mar. 26, 2015

(51) Int. Cl. F16K 17/02; B60J 5/00

(52) U.S. Cl. CPC F16K 17/02; B60J 5/00

(57) ABSTRACT

A number of variations may include a product comprising a reverse pressure relief valve for a vehicle door constructed and arranged to vent air, trapped between a primary and secondary door seal, into a vehicle door cavity when a vehicle door is being closed to reduce the door closing velocity.

### TECHNICAL FIELD

The field to which the disclosure generally relates to includes reverse pressure relief valves for vehicle doors.

### BACKGROUND

A vehicle may include one or more doors.

### SUMMARY OF ILLUSTRATIVE VARIATIONS

A number of variations may include a product comprising a reverse pressure relief valve for a vehicle door constructed and arranged to vent air, trapped between the primary and secondary door seals, into the vehicle door cavity when a vehicle door is being closed to reduce the door closing velocity.

A number of variations may include a reverse pressure relief valve for a vehicle door comprising: a body, wherein the body is hollow and includes a top portion and a bottom portion, wherein the top portion includes a flap and the bottom portion includes an opening, and wherein the reverse pressure relief valve is constructed and arranged to attach to a vehicle door.

A number of variations may include a method comprising cutting a flap into at least one vehicle door plug to convert at least one vehicle door plug into at least one reverse pressure relief valve.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of a reverse pressure relief valve according to a number of variations.

FIG. 2 illustrates a perspective side view of a reverse pressure relief valve according to a number of variations.

FIG. 3 illustrates a top view of a reverse pressure relief valve according to a number of variations.

FIG. 4 illustrates a bottom view of a reverse pressure relief valve according to a number of variations.

FIG. 5 illustrates a perspective view of a vehicle door according to a number of variations.

FIG. 6 illustrates a perspective view of a vehicle door with a reverse pressure relief valve according to a number of variations.

FIG. 7 illustrates a section view of a vehicle door with a reverse pressure relief valve according to a number of variations.

### DETAILED DESCRIPTION OF ILLUSTRATIVE VARIATIONS

The following description of the variations is merely illustrative in nature and is in no way intended to limit the scope of the invention, its application, or uses.

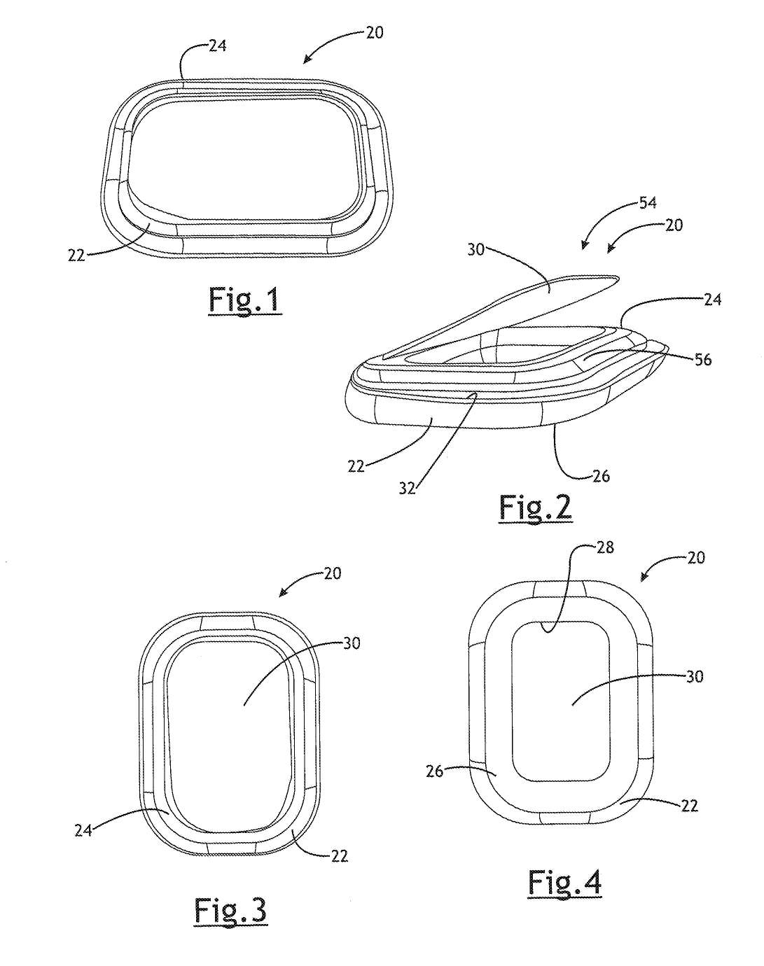

FIGS. 1-7 illustrate a reverse pressure relief valve 20 for a vehicle door 34 according to a number of variations. In a number of variations, when a vehicle door 34 is closing, air 46 may accumulate or be trapped between two or more door seals 48, 50 which may increase the velocity required to close the door 34. In a number of variations, one or more reverse pressure relief valves 20 may be inserted into the door 34 and may vent air which may accumulate between the two or more door seals 48, 50, by forcing the air flow 46 through the reverse pressure relief valve 20 and into the door cavity 36, a variation of which is illustrated in FIG. 7, which may reduce the velocity required to close the door 34. This may reduce the effort required by a vehicle operator to close the door 34. In one variation, the velocity required to close the door 34 may be reduced by up to 15% when one or more reverse pressure relief valves 20 are used. The reverse pressure relief valve 20 may be particularly useful when the vehicle door 34 is lightweight and/or when the vehicle cabin is small.

Referring to FIGS. 1-4, in a number of variations, a reverse pressure relief valve 20 may comprise a one-way valve. In one variation, the reverse pressure relief valve 20 may include a body 22 which may be hollow, and may include a top portion 24 and a bottom portion 26. The bottom portion 26 may include a cutout or opening 28, a variation of which is illustrated in FIG. 4, which may allow air to enter into the body 22. The top portion 24 may comprise a valve or flap 30 which may be constructed and arranged to open within the door cavity 36 when air may enter into the body 22 during closing of the door 34. The flap 30 may also be constructed and arranged so that when the door 34 is not closing, the flap 30 may remain closed which may prevent wind noise, dirt, water, and/or other contaminants from entering into the door cavity 36. The body 22 may also include an indentation or a groove 32 which may extend along the perimeter of the body 22, a variation of which is illustrated in FIG. 2, which may be used to secure the reverse pressure relief valve 20 into an opening 38 in the vehicle door 34. The reverse pressure relief valve 20 may be any number of shapes and sizes including, but not limited to, rectangular, circular, square, or a variable radius shape, so that the pressure relief valve 20 may fit into an opening 38 in the vehicle door 34. In one variation, the reverse pressure relief valve 20 may be constructed from a vehicle door plug 54 which may be modified by cutting a flap 30 into the top portion of the plug 56, a variation of which is illustrated in FIG. 2. The reverse pressure relief valve 20 may be any number of materials including, but not limited to, plastic or rubber.

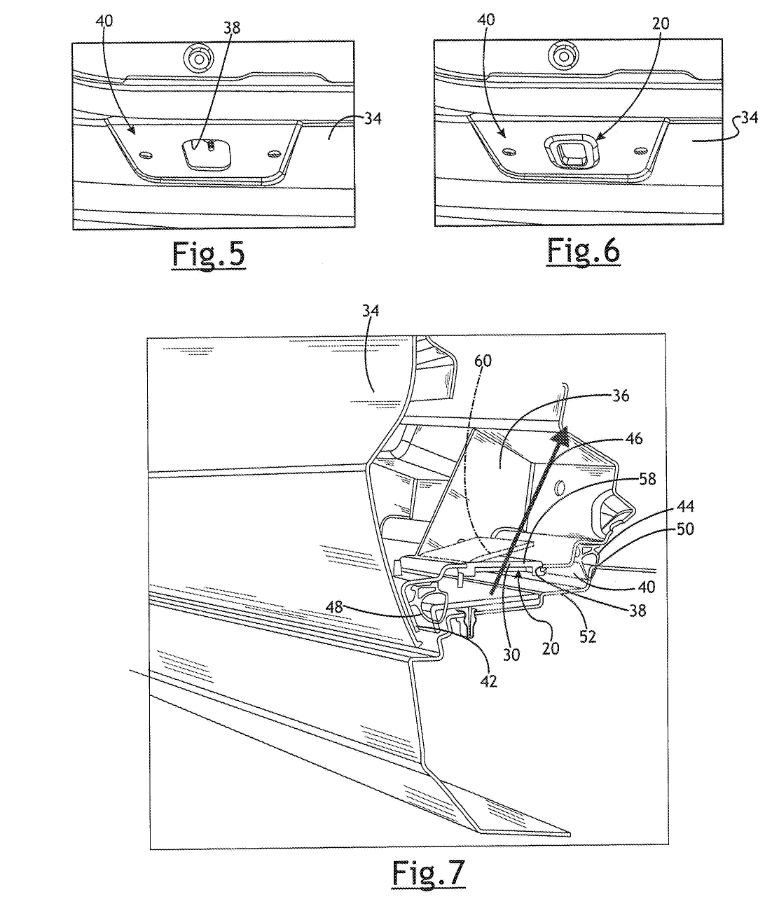

Referring to FIGS. 5-7, in a number of variations, one, two, or more than two reverse pressure relief valves 20 may be inserted into one or more openings 38 in the vehicle door 34 which may be located along the shut face 40 of the door 34 and may be located between two or more door seals 48, 50. The one or more reverse pressure relief valves 20 may be attached to the shut face 40 so that the top portion 24 sits within the door cavity 36 and the bottom portion 26 sits outside the door 34, a variation of which is illustrated in FIG. 7. The one or more pressure relief valves 20 may be inserted into the one or more openings in any number of variations including, but not limited to, snap-fitting or press-fitting. In a number of variations, the one or more openings 38 on the vehicle door 34 may be preexisting and the one or more reverse pressure relief valves 20 may be constructed and arranged to be inserted into the one or more openings 38. In another variation, one or more openings 38 may be added into the door 34 along the shut face 40 to accommodate one or more reverse pressure relief valves 20.

Referring to FIG. 7, in a number of variations, a vehicle door 34 may include a primary door seal 48 which may extend along a first lower edge 42 of the vehicle door 34 shut face 40 and a secondary door seal 50 which may extend along a second lower edge 44 of the vehicle door 34 shut face 40. In another variation, the secondary seal 50 may be attached to the interior 52 of the vehicle adjacent to the shut face 40 on the door 34. In one variation more than one primary door seal 48 and/or secondary door seal 50 may be used. The primary and secondary door seals 48, 50 may be constructed and arranged to prevent or reduce noise and/or contaminants from entering into the occupant cabin of the vehicle when the vehicle door 34 may be in a closed condition. One or more reverse pressure relief valves 20 may be positioned on any number of locations along the shut face 40 of the door 34 so that the reverse pressure relief valve 20 may be between the primary and secondary door seals 48, 50. When the door 34 is not being closed, the flap 30 on the reverse pressure relief valve 20 may be in a closed position 58 which may prevent noise and contaminants from entering into the door cavity 36. When the door 34 is being closed, air which may be trapped between the door seals 48, 50 may push the flap 30 on the reverse pressure relief valve 20 to an at least partially open position 60 (illustrated in phantom) inside the door cavity 36 so that air flow 46 may be forced through the flap 30 and vented into the door cavity 36, which may reduce the velocity/effort required to close the vehicle door 64.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising a reverse pressure relief valve for a vehicle door constructed and arranged to vent air, trapped between the primary and secondary door seals, into a vehicle door cavity when a vehicle door is being closed to reduce a door closing velocity.

Variation 2 may include a product as set forth in Variation 1 wherein the reverse pressure relief valve further comprises a body having a top portion and a bottom portion, wherein the top portion comprises a flap and the bottom portion comprises an opening.

Variation 3 may include a product as set forth in any of Variations 1-2 wherein the reverse pressure relief valve further comprises a groove which extends around a perimeter of the reverse pressure relief valve and which is constructed and arranged to secure the reverse pressure relief valve to an opening in a vehicle door.

Variation 4 may include a product as set forth in any of Variations 1-3 further comprising a vehicle door and wherein the reverse pressure relief valve is secured to a shut face of the vehicle door.

Variation 5 may include a product as set forth in Variation 4 wherein the reverse pressure relief valve is constructed and arranged to prevent noise and contaminants from entering into a vehicle door cavity when the vehicle door is not closing.

Variation 6 may include a reverse pressure relief valve for a vehicle door comprising: a body, wherein the body is hollow and includes a top portion and a bottom portion, wherein the top portion includes a flap and the bottom portion includes an opening, and wherein the reverse pressure relief valve is constructed and arranged to attach to a vehicle door.

Variation 7 may include a reverse pressure relief valve for a vehicle door as set forth in Variation 6 further comprising a vehicle door, and wherein the reverse pressure relief valve is attached to the vehicle door so that the top portion sits inside a vehicle door cavity and the bottom portion sits outside the vehicle door and air, trapped between at least one primary door seal and at least one secondary door seal, is vented through the reverse pressure relief valve and into the vehicle door cavity when the door is being closed.

Variation 8 may include a reverse pressure relief valve for a vehicle door as set forth in Variation 7 wherein the pressure relief valve is constructed and arranged so that the air trapped between the at least one primary door seal and the at least one secondary door seal flows into the body and through the flap into the vehicle cavity when the vehicle door is being closed.

Variation 9 may include a reverse pressure relief valve for a vehicle door as set forth in any of Variations 7-8 wherein the reverse pressure relief valve is a one-way valve which is constructed and arranged to open inward within the vehicle door cavity when the vehicle door is being closed.

Variation 10 may include a reverse pressure relief valve for a vehicle door as set forth in any of Variations 7-9 wherein the reverse pressure relief valve is constructed and arranged to prevent noise and contaminants from entering into the vehicle door cavity when the vehicle door is not closing.

Variation 11 may include a reverse pressure relief valve for a vehicle door as set forth in any of Variations 7-10 wherein the reverse pressure relief valve further comprises a groove around a perimeter of the body which is constructed and arranged to secure the reverse pressure relief valve to a vehicle door.

Variation 12 may include a reverse pressure relief valve for a vehicle door as set forth in any of Variations 7-11 wherein the reverse pressure relief valve is secured to an opening in a shut face of the vehicle door.

Variation 13 may include a reverse pressure relief valve for a vehicle door as set forth in any of Variations 7-12 wherein when the vehicle door is closed, the reverse pressure relief valve is situated between the at least one primary door seal and the at least one secondary door seal.

Variation 14 may include a method comprising cutting a flap into at least one vehicle door plug to convert the at least one vehicle door plug into at least one reverse pressure relief valve.

Variation 15 may include a method as set forth in Variation 14 further comprising installing the at least one reverse pressure relief valve into a vehicle door and venting air between at least one primary door seal and at least one secondary door seal through the reverse pressure relief valve and into a cavity of the vehicle door when the vehicle door is being closed to reduce a velocity needed to close the vehicle door.

Variation 16 may include a method as set forth in Variation 15 wherein the at least one reverse pressure relief valve is secured to a shut face of the vehicle door.

Variation 17 may include a method as set forth in any of Variations 15-16 wherein the at least one reverse pressure relief valve prevents noise and contaminants from entering into the cavity of the vehicle door when the vehicle door is not closing.

The above description of select variations within the scope of the invention is merely illustrative in nature and, thus, variations or variants thereof are not to be regarded as a departure from the spirit and scope of the invention.

1. A product comprising a reverse pressure relief valve for a vehicle door constructed and arranged to vent air, trapped between a first vehicle door seal and a second vehicle door seal, into a vehicle door cavity when a vehicle door is being closed to reduce a door closing velocity.

2. The product of claim 1 wherein the reverse pressure relief valve further comprises a body having a top portion and a bottom portion, wherein the top portion comprises a flap and the bottom portion comprises an opening.

3. The product of claim 1 wherein the reverse pressure relief valve further comprises a groove which extends around a perimeter of the reverse pressure relief valve and which is constructed and arranged to secure the reverse pressure relief valve to an opening in a vehicle door.

4. The product of claim 1 further comprising a vehicle door and wherein the reverse pressure relief valve is secured to a shut face of the vehicle door.

5. The product of claim 4 wherein the reverse pressure relief valve is constructed and arranged to prevent noise and contaminants from entering into a vehicle door cavity when the vehicle door is not closing.

6. A reverse pressure relief valve for a vehicle door comprising: a body, wherein the body is hollow and includes a top portion and a bottom portion, wherein the top portion includes a flap and the bottom portion includes an opening, and wherein the reverse pressure relief valve is constructed and arranged to attach to a vehicle door.

7. The product of claim 6 further comprising a vehicle door, and wherein the reverse pressure relief valve is attached to the vehicle door so that the top portion sits inside a vehicle door cavity and the bottom portion sits outside the vehicle door and air, trapped between at least one first door seal and at least one second door seal, is vented through the reverse pressure relief valve and into the vehicle door cavity when the door is being closed.

8. The product of claim 7 wherein the pressure relief valve is constructed and arranged so that the air trapped between the at least one first door seal and the at least one second door seal flows into the body and through the flap into the vehicle cavity when the vehicle door is being closed.

9. The product of claim 7 wherein the reverse pressure relief valve is a one-way valve which is constructed and arranged to open inward within the vehicle door cavity when the vehicle door is being closed.

10. The product of claim 7 wherein the reverse pressure relief valve is constructed and arranged to prevent noise and contaminants from entering into the vehicle door cavity when the vehicle door is not closing.

11. The product of claim 7 wherein the reverse pressure relief valve further comprises a groove around a perimeter of the body which is constructed and arranged to secure the reverse pressure relief valve to a vehicle door.

12. The product of claim 7 wherein the reverse pressure relief valve is secured to an opening in a shut face of the vehicle door.

13. The product of claim 7 wherein when the vehicle door is closed, the reverse pressure relief valve is situated between the at least one first door seal and the at least one second door seal.

14. A method comprising cutting a flap into at least one vehicle door plug to convert the at least one vehicle door plug into at least one reverse pressure relief valve.

15. The method of claim 14 further comprising installing the at least one reverse pressure relief valve into a vehicle door and venting air between at least one first door seal and at least one second door seal through the reverse pressure relief valve and into a cavity of the vehicle door when the vehicle door is being closed to reduce a velocity needed to close the vehicle door.

16. The method of claim 15 wherein the at least one reverse pressure relief valve is secured to a shut face of the vehicle door.

17. The method of claim 15 wherein the at least one reverse pressure relief valve prevents noise and contaminants from entering into the cavity of the vehicle door when the vehicle door is not closing.
